(19) United States
(12) Patent Application Publication
(10) Pub. No.: US 2014/0267695 A1
(43) Pub. Date: Sep. 18, 2014

(54) DEVICE AND METHOD FOR OPTICAL MEASUREMENT OF A VOLUME OF DISPENSED FLUID

(71) Applicant: VISTALAB TECHNOLOGIES, INC., Brewster, NY (US)

(72) Inventors: Richard Scordato, Pound Ridge, NY (US); Jeffrey Calhoun, Pleasantville, NY (US)

(73) Assignee: VistaLab Technologies, Inc., Brewster, NY (US)

(21) Appl. No.: 13/837,349

(22) Filed: Mar. 15, 2013

(51) Int. Cl. G01F 17/00; G01N 21/11

(52) U.S. Cl. CPC G01F 17/00; G01N 21/11
USPC 348/135; 356/246

(57) ABSTRACT

A method and system for optical measurement of a volume of dispensed fluid may be provided such as in connection with the calibration of pipettes. The method and system may include utilizing a fluid receptacle, an image recording device, and an image processing application to provide optical measurement of the volume of the dispensed fluid. The fluid receptacle may include a first plate and a second plate. The first and second plates may include respective opposing surfaces spaced apart from one another by a predetermined distance to define a space between the opposing surfaces. At least one of the first plate and the second plate may be substantially transparent to ensure that the dispensed fluid received in the space of the fluid receptacle is visible to the image recording device.

### CROSS-REFERENCE TO RELATED APPLICATIONS

None.

### BACKGROUND

1. Field of Invention

The invention relates generally to fluid volume measurement and, more particularly, to a device and method for optical measurement of a volume of dispensed fluid such as, for example, in connection with the calibration of pipettes.

2. Related Art

Handheld, air-displacement pipettes are commonly used in laboratories to measure and dispense fluids. These pipettes typically dispense from 1 microliter (uL) to 1000 uL, for example, although smaller and larger volumes are sometimes employed. Single channel, mechanically-operated pipettes with disposable plastic pipette tips are most commonly used for this purpose. However, multiple channel pipettes (e.g., having eight or twelve channels), pipettes that employ motors and microcontrollers to aspirate and dispense, and even robotically-controlled pipettes are being used more and more frequently.

It is common laboratory practice to periodically check the delivery or “calibration” of these pipetting devices in order to insure that they are delivering the desired volume. The most common method of determining the volume dispensed is to weigh the fluid dispensed (usually distilled water) on an accurate laboratory balance. The volume of the fluid dispensed may then be calculated, for example, by multiplying the weight of the sample by the specific gravity of the fluid (corrected for the temperature of the fluid and atmospheric pressure). In addition, since fluid is evaporating during the measurement process, an estimate of the evaporative loss must be included in the analysis. To calibrate a handheld pipette, a technician may typically dispense between four and ten samples at each of the minimum volume, mid-point volume, and maximum volume range for a particular pipette. The mean and standard deviation of the dispensed volumes may be calculated at each volume and these would be compared to the specifications required for the particular pipette. If the pipette does not meet specifications, repair and/or recalibration may be performed.

For volumes above approximately 100 μL, weighing the dispensed fluid on a laboratory balance is typically a relatively straightforward and reasonably accurate method. When the volumes are smaller, however, particularly below 10 μL, the weighing method of calibration becomes much more difficult and requires specialized equipment and expertise. A 10 μL droplet of water, for example, weighs approximately 0.01 grams. To measure this to an accuracy of 0.1%, a balance with accuracy to 0.00001 grams is required. Balances of this accuracy are sensitive, expensive instruments usually mounted on special vibration dampening granite tables. In addition, evaporative loss at low volumes can be relatively significant and special humidity control and compensation must be used to account for this effect.

Multiple channel pipettes such as, for example, eight- and twelve-channel pipettes pose another problem. In order to calibrate each channel of these pipettes on a laboratory balance, separate dispenses and weighings must be taken for each channel. To test the minimum, mid-point, and maximum volumes of each using, for example, four determinations, would require a minimum of 144 separate dispenses and weighings. This is time consuming and arduous work.

Another pipette calibration technique, as disclosed, for example, in U.S. Pat. No. 5,298,978 to Curtis, incorporated herein by reference, employs carefully formulated dyes to determine the dilution effect of dispensed liquid. This method may solve some of the issues of weighing the sample, but also requires an expensive photometer and expensive dyes for each determination. It is also generally understood as being less accurate than the weighing method. Other methods of calibration are also known, but none are widely used either because they require highly specialized, expensive equipment or do not provide the desired accuracy.

Because of the time and specialized equipment required for calibration, many laboratories send their pipettes to a specialized service for calibration. These service providers typically have the proper weighing equipment and often are housed in temperature and humidity controlled environments. The service providers may also be qualified to repair the pipette if required. One problem associated with sending pipettes out for calibration, however, is that the laboratory must generally rearrange their work schedule around the time the pipettes are at the calibration facility.

Another problem associated with pipette calibration relates to the frequency of calibration. Laboratories may typically have their pipettes calibrated every six months. Some labs may calibrate more frequently and others less so, depending upon the criticality of the work done and standards of practice for the lab. If a particular pipette is found to be out-of-calibration, however, the lab may not know exactly when this initially occurred, only that it could have occurred at any time since the last successful calibration of the pipette. In critical applications, this can require an arduous, detailed analysis of all results potentially affected by the particular pipette during the relevant time period in order to determine if any test results were compromised due to an out-of-calibration pipette.

### SUMMARY

What is needed is a device, system and method for optical measurement of a volume of dispensed fluid such as, for example, in connection with the calibration of a pipette or other fluid dispensing mechanism. The device, system and method should provide accurate and precise measurements and should be relatively inexpensive and simple such that performance can be readily achieved in a laboratory setting.

In accordance with an embodiment of the invention, a method and system for optical measurement of a volume of dispensed fluid may be provided such as, for example, in connection with the calibration of pipettes. The method and system may include utilizing a fluid receptacle, an image recording device, and an image processing application to provide optical measurement of the volume of the dispensed fluid. In accordance with an embodiment, the fluid receptacle may include a first plate and a second plate. The first and second plates may include respective opposing surfaces spaced apart from one another by a predetermined distance to define a space between the opposing surfaces. At least one of the first plate and the second plate may be substantially transparent to ensure that the dispensed fluid received in the space of the fluid receptacle is visible to the image recording device.

In accordance with an embodiment of the invention, the system for optical measurement of a volume of dispensed fluid may include the fluid receptacle and an image recording device arranged to record an optical image of the fluid received in the space of the fluid receptacle. The system may include a processor configured to receive the optical image of the fluid disposed within the fluid receptacle from the image recording device and process the image to determine the volume of fluid. The image recording device may comprise a digital camera. The system may include a smartphone device and the digital camera and the processor may be integrated components of the smartphone device.

In accordance with an embodiment of the invention, the method for optical measurement of a volume of fluid may include the steps of dispensing a volume of fluid into a fluid receptacle having first and second plates with respective opposing surfaces spaced apart from one another by a predetermined distance to define a space between the opposing surfaces, recording an optical image of the fluid received in the space of the fluid receptacle, and processing the optical image of the fluid to determine the volume of the fluid.

According to embodiments of the invention, two plates may be separated by a known and accurately controlled distance. A fluid volume to be measured may be introduced between the plates, for example, via an opening in one of the plates. At least one of the plates or a frame or holder connected to a plate may have calibration marks or indicia thereon which may be accurately placed a known distance in relation to each other. A spacing between the plates may be such that the fluid between the plates spreads out so that thickness of the fluid between the plates is substantially less than the dimensions of the fluid contacting the plates. At least one of the plates may be transparent so that the fluid contacting that plate is visible. A digital smartphone camera, for example, may be focused on the fluid through the transparent plate and an image of the fluid contacting the plate may be taken. The fluid that is introduced between the plates may preferably be dyed so that there is a strong contrast between the fluid boundary and the background. Software analysis may be performed on the image to determine a number of pixels in the image of the fluid using software methods well known to the art. The number of pixels in the fluid image may then be converted into the area of fluid contacting the plate by utilizing the indicia or other physical characteristic of the plates or plate holder to calibrate the image. Finally, the area of the fluid contacting the plate may be multiplied by a known (predetermined) distance between the plates to calculate the volume of the fluid between the plates.

The plates can be configured to have multiple measuring areas so that more than one fluid sample can be dispensed between the plates. These multiple areas can be used to make multiple measurements from the same pipette or take a sample from all the channels of a multichannel pipette simultaneously.

In accordance with embodiments, a camera on a smartphone such as, for example but not limited to, an iPhone, may be utilized to take the image of the fluid sample. A smartphone “app” may be used to analyze the image data and calculate the volume dispensed as well as compute the mean and standard deviation of the volumes delivered. These volumes may then be compared to required specifications of a fluid dispensing device. The app can share data with a database that may store and trend all the calibration information. The smartphone may also read a barcode or other optical machine-readable data feature that may be printed on the plates and that may provide key parameters such as, for example but not limited to, the predetermined distance between the plates, information on the indicia, date of manufacture, etc. The smartphone can also read a barcode label that is placed on a pipette so that the pipette and the data from it are recorded accurately.

In an embodiment, a disposable device may be provided comprising two plates spaced a known or predetermined distance apart. One or more of the plates may include multiple openings to allow passage of a fluid into substantially separated spaces between the plates. A user can dispense a dye solution into the device and take a picture with, for example, a standard cell phone camera. The delivered volumes may be measured accurately and reported back to the user immediately. The data can be transmitted to a database for further record keeping. No expensive equipment is required and great accuracy can be obtained. In addition, confining the fluid between the plates may substantially reduce evaporative loss.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a perspective view of a fluid receptacle according to an embodiment of the invention;

FIG. 2 is an illustrative top view of the fluid receptacle of FIG. 1;

FIG. 3 is an illustrative cross-sectional side view of the fluid receptacle of FIG. 1 taken along the line FIG. 3-FIG. 3 in FIG. 2;

FIGS. 4A, 4B, and 4C are illustrative top views of the fluid receptacle of FIG. 1 having a visible volume of dispensed fluid received therein according to an embodiment of the invention;

FIG. 5A is a perspective view of another fluid receptacle having multiple fluid receiving areas according to an embodiment of the invention;

FIG. 5B is a perspective view of the fluid receptacle of FIG. 5A shown including an optical machine-readable data feature according to another embodiment of the invention;

FIGS. 6A and 6B are perspective views of an exemplary setup for the optical measurement of a volume of dispensed fluid received in the fluid receptacles of FIGS. 5A and 5B, respectively; and

FIG. 7 depicts an illustrative embodiment of a computer system (e.g., a smartphone) that may be used in association with, in connection with, and/or in place of, e.g., but not limited to, any of the foregoing components and/or systems according to an embodiment of the invention.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention.

FIG. 1 is an illustrative perspective view of a fluid receptacle 10 according to an example embodiment of the invention. FIG. 2 is an illustrative top view of the fluid receptacle 10 of FIG. 1. The fluid receptacle 10 may be suitable for use in the optical measurement of a volume of fluid such as, for example, in connection with the calibration of a pipette or other fluid dispensing mechanism. As shown in FIGS. 1 and 2, the fluid receptacle 10 may include a first (top) plate 12 and a second (bottom) plate 14 spaced from the first plate 12. The plates 12, 14 may include respective opposing surfaces spaced apart from one another by a predetermined distance to define a space 20 therebetween (see FIG. 3). The plates 12, 14 may be coupled to one another. The first plate 12 may be substantially transparent or, alternatively, may have at least a portion thereof that is substantially transparent. As shown in FIGS. 1 and 2, the plates 12, 14 may be spaced from one another by a spacer 13. The spacer 13 may define the predetermined distance between the plates 12, 14 and may couple the plates to one another. The plate 12 may include an opening 16 such as, for example, a port or through hole, arranged to permit passage of a fluid into the space 20. The plate 12 may include another opening 17 which may function as a vent such as, for example, to allow air in the space 20 to escape when a fluid is introduced into the space via opening 16. The vent opening 17 may be covered by a semi-permeable membrane (not shown) which may be configured, for example, to keep fluid in space 20 and let air or other gases out. One or more indicia marks 18, 19 may be included on the plate 12 and may be accurately spaced in relation to each other to provide a known defined scale in order to calibrate an image taken of the fluid receptacle 10. Additional and/or alternative embodiments and features of the fluid receptacle 10 will be described in further detail below.

FIG. 3 is an illustrative cross-sectional side view of the fluid receptacle 10 of FIG. 1 taken along the line FIG. 3-FIG. 3 in FIG. 2. As shown in FIG. 3, the opposing surfaces 12a, 14a of plates 12, 14, respectively, are spaced apart from one another by a predetermined distance to define the space 20 therebetween. The predetermined distance between the opposing surfaces 12a, 14a of the plates 12, 14 may be substantially less than the two-dimensional area defined by any fluid 22 (see FIGS. 4A-C) introduced into space 20 and spreading in contact with the surfaces 12a, 14a as further described below.

FIGS. 4A, 4B, and 4C are illustrative top views of the fluid receptacle 10 of FIG. 1 each having a visible volume of dispensed fluid 22 received therein according to an embodiment of the invention. For example, a volume of fluid 22 may be dispensed by a pipette (not shown) through opening 16 into space 20. The fluid 22 may be a colored dye solution to increase contrast in any recorded image thereof. As can be seen in FIGS. 4A-C, the resulting shape of the fluid samples 22, 22′, 22″ upon receipt between plates 12, 14 in fluid receptacle 10 can vary significantly and the image analysis software utilized must detect the boundary of the fluid 22 reliably to ensure accurate and precise measurements. FIG. 4C, for example, shows a bubble 24 contained in the fluid 22″ that must be accounted for. Commercially available software, further described herein, is currently able to account for such variations and distinctions. As shown in FIGS. 4A-C, the fluid 22 does not occlude opening 16 (the loading port) when received in space 20. This is because the predetermined distance between the plates 12, 14 is substantially less than the dimension of the opening 16. Accordingly, capillary action will draw the fluid 22 out of the area of opening 16.

FIG. 5A is a perspective view of another example fluid receptacle 100 having multiple fluid receiving areas 120a, 120b, 120c, . . . 120n according to an embodiment of the invention. Like fluid receptacle 10, the fluid receptacle 100 may be suitable for use in the optical measurement of a volume of fluid such as, for example, in connection with the calibration of a pipette or other fluid dispensing mechanism. Fluid receptacle 100 may include multiple fluid receiving areas 120a, 120b, 120c, . . . 120n and, thus, may be especially suited for the calibration of a multiple channel pipette such as, for example, an eight or twelve channel pipette which typically have the channels arranged in a line on 4.5 mm or 9 mm spacing, although a pipette having any number of channels or spacing is contemplated. As shown in FIG. 5A, the fluid receptacle 100 may include a first (top) plate 112 and a second (bottom) plate 114 spaced from the first plate 112. The plates 112, 114 may include respective opposing surfaces spaced apart from one another by a predetermined distance to define a space therebetween, which may include a plurality of substantially separate spaces or fluid receiving areas 120a, 120b, . . . 120n. The first plate 112 may be substantially transparent or, alternatively, may have at least a portion thereof that is substantially transparent. As shown in FIG. 5A, the plates 112, 14 may be spaced from one another by a spacer 113 which may also serve to divide the space between the plates into the plurality of substantially separate spaces 120a, 120b, . . . 120n. The spacer 113 may define the predetermined distance between the plates 112, 114 and may couple the plates to one another. The plate 112 may include a plurality of openings 116a, 116b, . . . 116n such as, for example, a plurality of ports or through holes, arranged to permit passage of a fluid into the respective spaces 120a, 120b, etc. The plate 112 may include another plurality of openings 117a, 117b, . . . 117n, associated with respective spaces 120a, 120b, . . . 120n, and which may function as vents such as, for example, to allow air in the spaces 120n to escape when a fluid is introduced into the spaces 120n via the respective opening 116n.

While the fluid receptacle 100 depicted in FIG. 5A includes eight fluid receiving areas 120a, 120b, 120c, . . . 120n and thus, may, for example, allow the calibration of an eight channel pipette, a fluid receptacle having any number of fluid receiving areas 120 could be made in this configuration to enable calibration of pipettes with more or fewer channels. For example, a fluid receptacle may be provided having four fluid receiving spaces (not shown). The spacing could be arranged, for example, so that two of such four-channel devices could be abutted to one another to make an eight-channel device and three could be abutted to the others to make a twelve channel device. Such a configuration may allow a customer to buy a number of fluid receptacles in only one size. The customer can utilized an individual fluid receptacle to test a single channel pipette, or could put two or more such fluid receptacles together to test an eight-channel or a twelve-channel pipette.

FIG. 5B is a perspective view of the fluid receptacle 100′ of FIG. 5A shown including an optical machine-readable data feature 130 according to another embodiment of the invention. As shown in 5B, the optical machine-readable data feature 130 may be, for example but not limited to, a bar code visibly arranged on the fluid receptacle 100′. The optical machine-readable data feature 130 may be configured to convey key parameters or information about the fluid receptacle 100′ such as, for example but not limited to, the predetermined distance between the plates, information on the indicia marks, date of manufacture and/or other manufacturing lot information, number of fluid receiving spaces (channels), volume capacity, etc. The optical machine-readable data feature 130 may be printed or etched on one or more of the plates and may be readable by the image recording device discussed further below.

FIGS. 6A and 6B are perspective views of an exemplary setup for the optical measurement of a volume of dispensed fluid received in any of the described fluid receptacles 10, 100, 100′. As shown in FIG. 6A, a smartphone device 200 having an integrated image recording device (digital camera) 210 may be mounted on a stand or support element 300. The fluid receptacle 100 is shown positioned within a field of view of the digital camera 210 for optical measurement of a volume of dispensed fluid received in one or more of the fluid receiving areas of receptacle 100. The stand or support 300 may be utilized to hold the digital camera 210 and the fluid receptacle 100 in a fixed alignment. The stand 300 may make it easier to record an image of the fluid in the receptacle 100 by reducing movement that could otherwise blur the image. As shown in FIG. 6B, the receptacle 100′ may include an optical machine-readable data feature 130 (e.g., a bar code or the like) which may be read by the digital camera 210 of the smartphone device 200 to allow the device 200 to obtain key parameters or information about the fluid receptacle 100′ for processing.

In order to calibrate typical pipettes to their published specifications, a calibration system should have accuracy to at least 0.10% or 1 part in 1000. Accordingly, a resolution of a camera used to take an image must have sufficient resolution for the size of the fluid drop. A typical camera on a cell phone may have at least 5 megapixels of resolution and a minimum field of view of about 50 mm×70 mm or 3500 mm². In order to have an image with at least 1000 pixels of resolution, the image must be at least 3500×1000/5,000,000=0.7 mm².

According to embodiments of the invention, the distance between the plates 12, 14 should be controlled to better than 0.1% in order to achieve desired accuracy. The distance can be determined at the time of manufacture of the fluid receptacle or may be determined after manufacture by a number of methods including, for example, laser measurement or calibrating the plates 12, 14 by injecting a known volume of fluid. In the case of laser measurement, for example, a number of measurements can be taken over the area of the plates 12, 14 to provide a mean distance between the plates 12, 14 for different regions of the plates 12, 14. The distance between plate 12 and 14 need not be constant so long as the characteristics of the variation in distance are known or measured to the required accuracy. The determined or calibrated distance can be encoded, for example, by barcode onto one of the plate 12, 14.

In order to calibrate a range of pipettes from, for example, 1 μL to 1000 μL, a single predetermined distance between the plates cannot be practically used. For a given spacer distance, a practical range of calibration is a 10:1 range of volumes. In an embodiment, at least three different spacer thicknesses may be required to cover a desired range of pipette calibrations. The spacer may be color-coded so that the spacer distance is readily apparent to a user. Table 1 gives exemplary nominal thicknesses and droplet diameter (assuming a nominal circular drop) to cover a proposed range of pipette calibrations.

TABLE 1

| | | |
|---|---|---|
| Spacer | Volume | Diameter |
| Thickness | range (μL) | Range (mm) |

| (mm) | Minimum | Maximum | Minimum | Maximum |
|---|---|---|---|---|
| 0.05 | 1 | 10 | 5.0 | 16.0 |
| 0.25 | 10 | 100 | 7.1 | 22.6 |
| 2.5 | 100 | 1000 | 7.1 | 22.6 |

In embodiments of the invention, the second (bottom) plate 14 may a light neutral color to provide a good background for taking an image of a fluid sample. The top plate 12 may be clear glass. Glass may be a good material for one or both of the top and bottom plates 12, 14 because glass that is extremely flat is inexpensive and readily available. Glass can also be treated to modify its surface energy as discussed below. Plastics such as polycarbonate or acrylic, however, can also be used. The spacer 13 must be dimensionally stable and can be made from glass or plastics such as, for example but not limited to, polyester, polycarbonate, acrylic, or combinations thereof. The spacer can also be integral with either the top or bottom plates, preferably the bottom plate. It may be possible to injection mold, machine or laser etch the bottom plate and spacer from a single piece of material. As the technology for stereolithography and additive machining advances, it may be possible to fabricate the entire assembly from a single piece of transparent material.

The top and bottom plates 12, 14 can be adhered to the spacer 13 by any of several methods well known in the art. Suitable adhesives include, for example but not limited to, ultraviolet light cured adhesives and cyanoacrylate adhesives or the like. The plates 12, 14 and spacer 13 can also be adhered by ultrasonic welding or heating and melting them together.

In another embodiment of this invention, the top plate 12 may be removable (not shown). In this case, the fluid sample 22 may be pipetted directly onto the bottom plate 14 and then the top plate 12 may be placed on the spacer 13. The spacer 13 may be smaller in thickness than the height of the droplet on the bottom plate 14 so that the top plate 12 contacts the fluid droplet when it is placed on the spacer 13. The droplet will then spread out between the top and bottom plates 12, 14 and be constrained either by capillary action or the side walls of the spacer 13. It may also be possible to pipette the fluid sample 22 between the edges of the top and bottom plates 12, 14 and have the fluid sample 22 be drawn between the plates 12, 14 via capillary action. The image of the droplet can then be taken as described previously. After the image is taken the top plate 12 may be removed, the top plate 12, bottom plate 14, and spacer 13 may be wiped dry and then another sample can be measured. Alternatively, the receptacle may be disposable and a new receptacle may be utilized for each test/calibration procedure. In accordance with another embodiment, it may possible to hingedly connect the top plate 12 and bottom plate 14 for ease use. In another embodiment, he spacers 13 can also be stepped so that indexing the stepped spacer can easily change the distance between to top and bottom plates 12, 14.

In order to make the fluid sample easier to see both visually and with the image analysis software, a dye can be used as the fluid sample or as part of the fluid sample. An exemplary dye for use in the system and method may include 0.30% Amido Naphthol Red G in a solution of 8% methanol in distilled water due to its very visible bright red color. It may be possible to alter the dye to mimic substances that are pipetted in the laboratory such as DMSO or Bovine Serum Albumin.

In order to produce accurate volume measurements of a liquid trapped between two plates it is important that the shape of the resulting droplet be coherent and continuous. A small number of included air bubbles can be handled by the analysis software, but multiple attached air bubbles, or any type of foaming cannot be tolerated. For this reason the aqueous solution of the fluid sample must be formulated to maximize the surface tension of the liquid itself. The water should be as pure as possible with no exposure to any type of surface energy lowering substances such as oils or surfactants. At the same time, the two plates may be selected to be as hydrophobic (low surface energy) as possible. The appropriate combination of liquid and plates may insure that the liquid has a greater affinity for itself than for the opposing surfaces of the plates. This may eliminate the formation of small non-occluding droplets and may insure that the liquid remains a cohesive mass for image recording and post processing.

Another surface tension consideration is the shape of the meniscus that is inherently formed around the edges of the water droplet when contained between the two plates. The contact angle(s) that the fluid makes with the respective plates at the outer periphery of the dispersed fluid, which is a function of the fluid/air/plate interface, may affect the meniscus and hence the fluid boundary observed by the camera. The shape of the meniscus is affected by the surface energies of the system components, as indicated above, and also by the distance between the two plates. The volume detection software may have built in compensation for the meniscus based on these factors and good results may depend on using new clean plate surfaces for every test as well as on absolute consistency of the water formulation.

In one embodiment, the bottom plate may be opaque white Polytetrafluoroetylene—(PTFE, Surface Energy=19.1 mJ/m 2) and the top plate may be Acrylic sheet (Surface Energy=40.0 mJ/m 2). These two materials both have much lower surface energy than clean water (Surface Energy=72.2 mJ/m 2), which ensures that the water sheet will be more attracted to itself than to either surface.

In another embodiment of the invention, the stability of the liquid trapped between the plates may be enhanced by pre-filling the gap with a non-soluble stable liquid such as silicone or fluorocarbon oil. The contrast between the clear oil and the colored water may provide a more stable boundary detection, and the presence of two liquids may make air bubble detection easier.

In another embodiment of the invention, the surface energy of the water may be increased with the addition of an inorganic solute such as salt (NaCl for example), or a trace amount of a metal such as magnesium, or iron.

Another variation includes surface preparation of the plates such as plasma treatment to further reduce surface energy and enhance hydrophobicity.

Where the image recording device and processing device comprise integrated components of a smartphone, an “app” stored and executed on the smartphone for the image processing and analysis may include a number of functions. The app may, for example, query the user for an identification number of a pipette to be tested/calibrated, the type of pipette (single channel, eight-channel etc.), the volume range of the pipette, the volume setting of the pipette and the specification range for the pipette. Once this information is entered it may be stored for future reference so it does not need to be re-entered. If a barcode label is affixed to the pipette, the app may read the bar code on the pipette and look up any previously entered information. The user will then be prompted to begin the calibration process.

After the user has pipetted the fluid sample and the image recording device (e.g., digital camera) has recorded an image for processing, image analysis software may locate each drop of fluid between the plates and may measure the perimeter and area of each drop. Commercially available software such as, for example, Able Image Analyser® (Mu Labs, Ljubljana, Slovenia, EU) and PAX-it Image Management and Image Analysis software (MIS Inc., Villa Park, Ill.), as well as open source software such as, for example, Image J (see http://rsbweb.nih.gov/ij/index.html), may be capable of this analysis. The software may check for errors or problems with the fluid sample such as, for example, too many bubbles or stray droplets and may dismiss a fluid sample that does not meet predefined acceptance criteria.

The software may calibrate the image by using the indicia marks or some other physical feature on or associated with the plates or plate holder such as the length and width of the plate or distance between openings (loading ports). A circular indicia mark 19 (see FIG. 1) can be used to directly calibrate the area of the samples. Cross marks 18 set at known locations and accurate distances from each other may define the field where the liquid is expected to be found. They may also used to verify that the photo for analysis is of acceptable quality and includes the full required area of the device.

An inked calibration dot of precisely known area may be used to verify the actual area for each plate using the detection algorithm. During the measurement of the liquid area, the calibration dot may also be measured and the result may compared to an online database. Any deviation for the expected value of the dot area may be flagged as an error condition.

In one embodiment of the invention, an accurately known volume of UV curable epoxy may be placed between the plates during manufacture to be used as a calibration dot. The properties of this liquid such as surface tension, viscosity, and color may be controlled so as to closely mimic the aqueous test liquid. The liquid epoxy may be cured until hard and may be used during measurement of the test liquid to provide a highly accurate and relevant calibration mechanism.

The software may also read the bar code on the fluid receptacle (calibration slide) to determine that the proper receptacle is being used for the type and volume of pipette being calibrated. The type of calibration slide (number of channels, volume capacity etc), the thickness of the spacer and other manufacturing lot information may be encoded on the calibration slide. An error message may be displayed if a discrepancy is detected.

Once the image is analyzed, the smartphone app may report the measured volume. Means and standard deviation may be computed for a series of tests according to standard testing protocols that may be defined in the software. The results of the analysis may be compared to the specifications and the results may be displayed along with, for example, a Pass or Fail indication. All the data is stored in memory and can be transferred to a master database via a wireless connection to the internet. Alerts can be programmed so that particular results can be emailed to a designated recipient.

The device and method according to embodiments of the invention may enable the measurement of fluid over a volume range such as, for example, over at least the volume range from 1 μL to 1000 μL.

The device and method according to embodiments of the invention may enable testing and calibration of single channel pipettes and/or multiple channel pipettes having, for example but not limited to, eight, twelve, or some less or greater number of channels simultaneously.

The device and method according to embodiments of the invention may provide a simple system of collecting data from pipette calibration for record keeping purposes.

In some embodiments, the distance between the plates may be known or predetermined, but may not necessarily be constant. For example, the distance between the plates could be tapered in one or more directions to move or direct fluid preferentially from one area to another.

In some embodiments, a detailed picture of the fluid receptacle or something like it could be used to calibrate a camera the first time it is used. For example, if a new model camera is used there can be a first-time setup procedure that processes this image and calibrates the camera resolution, field of view, distance from the slide, etc.

FIG. 7 depicts an illustrative embodiment of a computer system 1000 that may be used in association with, in connection with, and/or in place of, e.g., but not limited to, any of the foregoing components and/or systems. The system and method for optical measurement of a volume of fluid may include and/or be implemented using one or more such computer systems 1000.

The present embodiments (or any part(s) or function(s) thereof) may be implemented using hardware, software, firmware, or a combination thereof and may be implemented in one or more computer systems or other processing systems. In an embodiment, the invention may be directed toward one or more computer systems capable of carrying out the functionality described herein. An example of a computer system 1000 is shown in FIG. 7, which depicts a block diagram of an exemplary computer system which may be useful for implementing the present invention. Specifically, FIG. 7 illustrates an example computer 1000, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/VISTA, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a smartphone device, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 7.

The computer system 1000 may include one or more processors, such as, e.g., but not limited to, processor(s) 1004. The processor(s) 1004 may be connected to a communication infrastructure 1006 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 1000 may include a display interface 1002 that may forward, e.g., but not limited to, graphics, text, and other data, etc., from the communication infrastructure 1006 (or from a frame buffer, etc., not shown) for display on the display unit 1030.

The computer system 1000 may also include, e.g., but may not be limited to, a main memory 1008, random access memory (RAM), and a secondary memory 1010, etc. The secondary memory 1010 may include, for example, (but may not be limited to) one or more hard disk or solid state drives 1012 and/or a removable storage drive 1014, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 1014 may, e.g., but not limited to, read from and/or write to a remote or removable storage unit 1018 in a well-known manner. Removable storage unit 1018, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 1014. As will be appreciated, the removable storage unit 1018 may include a computer usable storage medium having stored therein computer software and/or data.

In alternative exemplary embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1022 and interfaces 1020, which may allow software and data to be transferred from the removable storage unit 1022 to computer system 1000.

Computer 1000 may also include an input device 1016 such as, e.g., (but not limited to) a mouse or other pointing device such as a digitizer, a keyboard or other data entry device (none of which are labeled), and/or a touchscreen integrated with display 1030, etc. Input device 1016 could also include, for example, an image recording device such as, for example, a digital camera.

Computer 1000 may also include output devices 1040, such as, e.g., (but not limited to) display 1030, and display interface 1002. Computer 1000 may include input/output (I/O) devices such as, e.g., (but not limited to) communications interface 1024, cable 1028 and communications path 1026, etc. These devices may include, e.g., but not limited to, a network interface card, and modems (neither are labeled). Communications interface 1024 may allow software and data to be transferred between computer system 1000 and external devices. Examples of communications interface 1024 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 1024 may be in the form of signals 1028 which may be electronic, electromagnetic, optical or other signals capable of being received by communications interface 1024. These signals 1028 may be provided to communications interface 1024 via, e.g., but not limited to, a communications path 1026 (e.g., but not limited to, a channel). This channel 1026 may carry signals 1028, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to non-transitory media such as, e.g., but not limited to removable storage drive 1014, a hard disk installed in hard disk drive, a solid state drive, and/or other storage device 1012, etc. These computer program products may provide software to computer system 1000. The invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, variables, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any tangible, non-transitory mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; and flash memory devices.

Computer programs (also called computer control logic) may include object oriented computer programs, and may be stored in main memory 1008 and/or the secondary memory 1010 and/or removable storage drive 1014, removable storage unit 1018, removable storage unit 1022, also called computer program products. Such computer programs, when executed, may enable the computer system 1000 to perform the features of the inventive embodiments discussed herein. In particular, the computer programs, when executed, may enable the processor or processors 1004 to perform steps for optical measurement of a volume of a dispensed fluid including, for example, the processing of an optical image of the dispensed fluid and determine the volume of the fluid based on known parameters of the fluid receptacle within which the fluid is received in accordance with the embodiments described herein.

In another exemplary embodiment, the invention may be directed to a computer program product comprising a computer readable medium having control logic (computer software) stored therein. The control logic, when executed by the processor 1004, may cause the processor 1004 to perform the functions of the invention as described herein. In another exemplary embodiment where the invention may be implemented using software, the software may be stored in a computer program product and loaded into computer system 1000 using, e.g., but not limited to, removable storage drive 1014, hard drive 1012 or communications interface 1024, etc. The control logic (software), when executed by the processor 1004, may cause the processor 1004 to perform the functions of the invention as described herein. The computer software may run as a standalone software application program running atop an operating system, may be integrated into the operating system, or may be integrated into another software program.

In yet another embodiment, the invention may be implemented primarily in hardware using, for example, but not limited to, hardware components such as one or more application specific integrated circuits (ASICs), field programmable gate-arrays (FPGAs), or other devices, etc. Implementation of a hardware device capable of performing the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiment of the present invention makes reference to, e.g., but not limited to, communications links, wired, and/or wireless networks. Wired networks may include any of a wide variety of well-known wired connections for coupling sensors, processors, and other devices together. Exemplary wireless network types may include, e.g., but not limited to, code division multiple access (CDMA), spread spectrum wireless, orthogonal frequency division multiplexing (OFDM), 1G, 2G, 3G, 4G wireless, Bluetooth, Infrared Data Association (IrDA—a standard method for devices to communicate using infrared light pulses), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc.

According to an embodiment, the methods set forth herein may be performed by one or more computer processor(s) adapted to process program logic, which may be embodied on a computer accessible storage medium, which when the program logic is executed on the exemplary one or more processor(s) may perform the steps as set forth in the methods.

While various embodiments of the present invention have been described above, it should be understood that they have been presented by way of example only, and not limitation. Although the foregoing description is directed to example embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A fluid receptacle for use in the optical measurement of a volume of fluid, comprising:
a first plate; and
a second plate,
wherein the first and second plates include respective opposing surfaces spaced apart from one another by a predetermined distance to define a space between the opposing surfaces, and
wherein at least one of the first plate and the second plate is substantially transparent.

2. The fluid receptacle according to claim 1, wherein the first plate and the second plate are coupled to one another.

3. The fluid receptacle according to claim 1, wherein at least one of the first plate and the second plate includes an opening arranged to permit passage of a fluid into the space.

4. The fluid receptacle according to claim 3, wherein the first plate is substantially transparent and includes the opening.

5. The fluid receptacle according to claim 3, wherein at least one of the first plate and the second plate comprises a second opening defining a vent.

6. The fluid receptacle according to claim 5, wherein the vent includes a semi-permeable cover configured to permit passage of air and to substantially prevent passage of the fluid therethrough.

7. The fluid receptacle according to claim 3, wherein the opening comprises a plurality of openings, and wherein the at least one of the first plate and the second plate includes one or more of the plurality of openings, each opening arranged to permit passage of the fluid into a respective one of the plurality of substantially separate spaces.

8. The fluid receptacle according to claim 1, further comprising:
a spacer disposed between the first and second plates, wherein the spacer provides the predetermined determined distance between the opposing surfaces of the first and second plates.

9. The fluid receptacle according to claim 8, wherein the spacer is integrally formed with at least one of the first and second plates.

10. The fluid receptacle according to claim 1, wherein the space comprises a plurality of substantially separate spaces.

11. The fluid receptacle according to claim 1, further comprising:
at least one indicia mark visibly arranged on the fluid receptacle.

12. The fluid receptacle according to claim 11, wherein the first plate includes the at least one indicia mark and an opening arranged to permit passage of a fluid into the space.

13. The fluid receptacle according to claim 12, wherein the first plate is substantially transparent.

14. The fluid receptacle according to claim 1, further comprising:
an optical machine-readable data feature visibly arranged on the fluid receptacle, wherein the optical machine-readable data feature is configured to convey information about the fluid receptacle.

15. The fluid receptacle according to claim 1, wherein at least one of the respective opposing surfaces of the first and second plates has been treated to modify a surface energy of the surface.

16. A system for optical measurement of a volume of dispensed fluid, comprising:
a fluid receptacle including:
a first plate; and
a second plate, wherein the first and second plates include respective opposing surfaces spaced apart from one another by a predetermined distance to define a space between the opposing surfaces, and wherein at least one of the first plate and the second plate is substantially transparent; and
an image recording device arranged to record an optical image of the fluid received in the space of the fluid receptacle.

17. The system according to claim 16, further comprising:
a processor configured to receive the optical image of the fluid disposed within the fluid receptacle from the image recording device and process the image to determine the volume of fluid.

18. The system according to claim 16, wherein the image recording device comprises a digital camera.

19. The system according to claim 18, further comprising a smartphone device, wherein the digital camera and the processor are integrated components of the smartphone device.

20. A method for optical measurement of a volume of fluid, the method comprising:
dispensing a volume of fluid into a fluid receptacle, the fluid receptacle having first and second plates with respective opposing surfaces spaced apart from one another by a predetermined distance to define a space between the opposing surfaces;
recording an optical image of the fluid received in the space of the fluid receptacle;
processing the optical image of the fluid to determine the volume of the fluid.

21. The method according to claim 20, wherein the processing comprises:
calculating a two-dimensional area of the optical image of the fluid; and
multiplying the calculated two-dimensional area of the optical image of the fluid by the predetermined distance between the opposing surfaces of the first and second plates.

22. The method according to claim 20, further comprising:
obtaining information about the fluid receptacle including the predetermined distance between the opposing surfaces of the first and second plates.

23. The method according to claim 22, wherein the obtaining information about the fluid receptacle comprises:
scanning an optical machine-readable data feature associated with the fluid receptacle, wherein the optical machine-readable data feature comprises the information about the fluid receptacle including the predetermined distance between the opposing surfaces of the first and second plates.

24. The method according to claim 20, further comprising:
storing the determined measured volume of the fluid in a database.

25. The method according to claim 24, wherein the storing comprises at least one of locally storing the determined measured volume of the fluid in a local database or transmitting the determined measured volume of the fluid for storage in a remote database.
